(19) United States
(12) Patent Application Publication
(10) Pub. No.: US 2025/0116968 A1
(43) Pub. Date: Apr. 10, 2025

(54) HOROLOGICAL DISPLAY MECHANISM

(71) Applicant: Montres Breguet S.A., L'Abbaye (CH)

(72) Inventors: Alain ZAUGG, Le Sentier (CH); Christophe RIEDO, Le Lieu (CH)

(73) Assignee: Montres Breguet S.A., L'Abbaye (CH)

(21) Appl. No.: 18/695,542

(22) PCT Filed: Oct. 19, 2022
(86) PCT No.: PCT/EP2022/079018

§ 371 Date: Mar. 26, 2024

(30) Foreign Application Priority Data
Oct. 21, 2021 (EP) 21204026.5

(51) Int. Cl. G04B 19/253; G04B 19/20

(52) U.S. Cl. CPC G04B 19/25313; G04B 19/202

(57) ABSTRACT

A horological display mechanism (100) including first drive elements (1) for rotating a first display wheel set (10) through a first number of steps in order to display a first magnitude, and second drive elements (2) for rotating a second display wheel set (20) through a second number of steps in order to display a second magnitude, this display mechanism (100) comprises coupling elements (3), separate from the first drive elements (1) and from the second drive elements (2), and which are arranged to index the first display wheel set (10) and the second display wheel set (20) relative to one another, to ensure their alignment, in an alignment direction (A), in a display area (30). The invention further relates to a timepiece (1000), in particular a watch, including such a display mechanism (100), in particular a calendar mechanism.

### CROSS REFERENCE TO RELATED APPLICATIONS

This application is a National Stage of International Application No. PCT/EP2022/079018 filed Oct. 19, 2022, claiming priority based on European Patent Application No. 21204026.5 filed Oct. 21, 2021.

### TECHNICAL FIELD OF THE INVENTION

The invention relates to a timepiece display mechanism comprising at least first drive elements arranged to rotate a first display wheel set through a first number of steps in order to display a first magnitude, and second drive elements arranged to rotate a second display wheel set through a second number of steps in order to display a second magnitude.

The invention further relates to a timepiece, in particular a watch, comprising such a display mechanism, in particular a calendar mechanism.

The invention relates to the field of horological display mechanisms.

### TECHNOLOGICAL BACKGROUND

In a horological display mechanism, the relative positioning of complementary displays is always a tricky problem to solve, as any misalignment, however slight, is highly visible to the user.

For example, rolling date displays, and the well-known big date display mechanisms, are typically composed of two separate displays for the units and for the tens.

In these types of displays, aligning the two indicators to give the illusion of a single display poses a crucial problem that must be overcome. As each indicator has its own mechanism for the rotation and positioning thereof, the relative positioning error is not negligible.

### SUMMARY OF THE INVENTION

The aim of the invention is to develop novel display mechanisms combining a plurality of display wheel sets, and to solve the problem of aligning the indicators in the display area.

To this end, the invention relates to a horological display mechanism according to claim 1.

The invention further relates to a timepiece, in particular a watch, comprising at least one such display mechanism, in particular a calendar mechanism.

### BRIEF DESCRIPTION OF THE FIGURES

The aims, advantages and features of the invention will be better understood on reading the detailed description which follows, with reference to the accompanying drawings, among which:

FIG. 1 diagrammatically shows a front view of a display mechanism comprising two display wheel sets, which are in this case discs or rings, of the big date type of the prior art, comprising a first display wheel set for displaying the 10 units, partially covered by a second display wheel set for displaying the tens; this second tens display wheel set is a display that is not concentric with the first units display wheel set, and comprises four tens indicators 0-1-2-3, each accompanied by an adjacent window, through which an indicator of the first units display wheel set can be seen; the tens indicator “2” can be read in the display area, and the units indicator “9” can be read through the adjacent window; It goes without saying that, to make the date easier to read for the user, only these two indicators will be visible through a window, or through a transparent area of the dial, or by any other elements allowing them to be highlighted;

FIG. 2 similarly illustrates a mechanism, which is based on the display mechanism of FIG. 1, and which has been improved by incorporating coupling elements, which in this case consist of, but are not limited to, series of ferromagnetic elements and series of magnets: the first units display wheel set comprises ten first coupling elements which are equidistant ferromagnetic elements, identified by a letter “F”, and the second tens display wheel set comprises four second coupling elements which are equidistant magnets, identified by a letter “U”. This mechanism solves the problem of aligning the displays by combining just one of the first ten coupling elements, which are ferromagnetic elements, with just one of the four second coupling elements, which are magnets, and gives the display positional stability; typically speaking, the magnetic couplings described within the scope of the invention can be either combinations of ferromagnetic elements arranged to face magnets (of random magnetisation direction), or combinations of magnets arranged to face other magnets, whose polarities must be in phase to ensure mutual attraction;

FIG. 3 illustrates, in a similar way to FIG. 2, a mechanism that has been improved in the same way, based on a display of the big date type of the prior art comprising a display of the 10 units, and above this a display, which is in this instance concentric with that of the units, of the four tens provided with as many windows through which an indicator of the first units display wheel set is visible. Ten first coupling elements formed by ferromagnetic units elements are positioned relative to the four second coupling elements formed by tens magnets; as before, it can be seen that if two second coupling elements formed by tens magnets are opposite two first coupling elements formed by ferromagnetic units elements, the other two are offset by half a step and are in contradiction with the first two, which is clearly visible through the window in the 9 o'clock position in the figure. This relative guidance of the two display wheel sets is thus not possible with more than two tens magnets, since the number of first ferromagnetic units elements is not a whole multiple of that of the second tens magnets;

FIG. 4 illustrates, in a similar way to FIGS. 2 and 3, which comprise similar magnetic coupling elements, a further improved mechanism, which is a big date display according to the invention comprising a display of the 10 units, and above this a concentric display of the 5 tens provided with as many windows or openings allowing the unit to be displayed therethrough. Magnetic positioning of ten first coupling elements formed by ferromagnetic elements relative to the five second coupling elements formed by tens magnets is suggested to guarantee optimum alignments; the use of duplicate indicators, in this case the “0” which has been duplicated on the second tens display wheel set, allows all of the displays to be produced, with each first indicator of the first units display wheel set being visible through a window in the second tens display wheel set, in all of the stable positions of these two wheel sets;

FIG. 5 illustrates the drive elements for the two display wheel sets of FIG. 4, comprising two eccentric wheels, each truncated, so as to allow the date to be displayed, which cooperate with pinions coaxial with the wheel sets, held in stable positions by jumpers; it should be noted that the invention creates a novel application for this type of drive by truncated wheels, in this novel use for driving a display, in particular in the non-limiting example illustrated here of a date display with five tens, one of which has been duplicated, and the wheel which has the function of driving the tens has one tooth more than in the known prior art for other mechanisms; in this non-limiting case of such a display with a duplicate “0” indication, the drive tooth is located on the sector between teeth 31-01 and 09-10;

FIG. 6 diagrammatically shows a front view of a timepiece, in this case a watch, comprising a display mechanism having two display wheel sets according to the invention; these two display wheel sets are in this case two coaxial rollers arranged side by side;

FIG. 7 is a block diagram showing a timepiece, in particular a watch, comprising a display mechanism having two display wheel sets according to the invention;

FIG. 8 diagrammatically shows a front view of the visible part of the second display wheel set in FIG. 4, the windows not being shown;

FIG. 9 shows, in a similar way to FIG. 8, the visible part of another second display wheel set according to the invention, in which the windows are not shown, the application in this case relating to a display of 10 tens and 10 units on a disc;

FIG. 10 shows, in a similar way to FIG. 8, the visible part of two overlapping concentric display wheel sets carrying indicators over different diameters;

FIG. 11 shows, in a similar way to FIG. 10, the visible part of two mutually external display wheel sets, with a display area above the first units wheel set only, for displaying a units indicator, and above the second tens wheel set only, for displaying a tens indicator;

FIG. 12 shows, in a similar way to FIG. 10, the visible part of two mutually external and partially overlapping display wheel sets, with a display area above the overlap area, for displaying a units indicator, and above the second tens wheel set only, for displaying a tens indicator;

FIG. 13 illustrates the reverse configuration of that shown in FIG. 12, with a display area above the first units wheel set only, for displaying a units indicator, and above the overlap area, for displaying a tens indicator;

FIG. 14 shows, in a similar way to FIG. 10, the visible part of two mutually external and partially overlapping display wheel sets, with a display area above the overlap area, for displaying a units indicator and a tens indicator, with the units indicator visible through a window in the second tens wheel set;

FIG. 15 diagrammatically shows a partial and perspective view of the drive elements for the two display wheel sets of FIG. 4, already shown in plan view in FIG. 5, and which comprise a truncated toothing allowing the 10-tooth pinion of the ten units to be driven 30 times out of 31, and a truncated toothing allowing the 5-tooth pinion of the five tens to be driven 5 times out of 31, in this particular application;

FIG. 16 diagrammatically shows a partial side view of an example embodiment of a display mechanism having two display wheel sets, which are in this case discs or rings, comprising purely mechanical coupling elements.

### DETAILED DESCRIPTION OF THE INVENTION

The invention relates to a display mechanism combining a plurality of display wheel sets, arranged to solve the problem of aligning the indicators in the display area.

The invention thus relates to a horological display mechanism 100, which comprises at least first drive elements 1 arranged to rotate, through a first number of steps, a first display wheel set 10 for displaying a first magnitude, and second drive elements 2 arranged to rotate, through a second number of steps, a second display wheel set 20 for displaying a second magnitude.

According to the invention, this display mechanism 100 comprises coupling elements 3, 3′ which are separate from the first drive elements 1 and the second drive elements 2. The coupling elements 3, 3′ are arranged solely to index the position of the first display wheel set 10 and the second display wheel set 20 relative to each other, and to ensure their alignment, in an alignment direction A, in a display area 30 comprised in the display mechanism 100.

Thus, independently of the first drive elements 1 and the second drive elements 2, of the first display wheel set 10 and the second display wheel set 20 respectively, the coupling elements 3, 3′ do not allow the first display wheel set 10 and the second display wheel set 20 to be driven to the next step.

More particularly, the coupling elements 3, 3′ are arranged to provide such alignment coupling magnetically and/or mechanically.

In a particular alternative embodiment, the coupling elements 3 are arranged to provide such alignment coupling magnetically only. In another particular alternative embodiment, the coupling elements 3 are arranged to provide such alignment coupling magnetically and mechanically.

More particularly, the steps of the first display wheel set 10 are constant, and the steps of the second display wheel set 20 are constant.

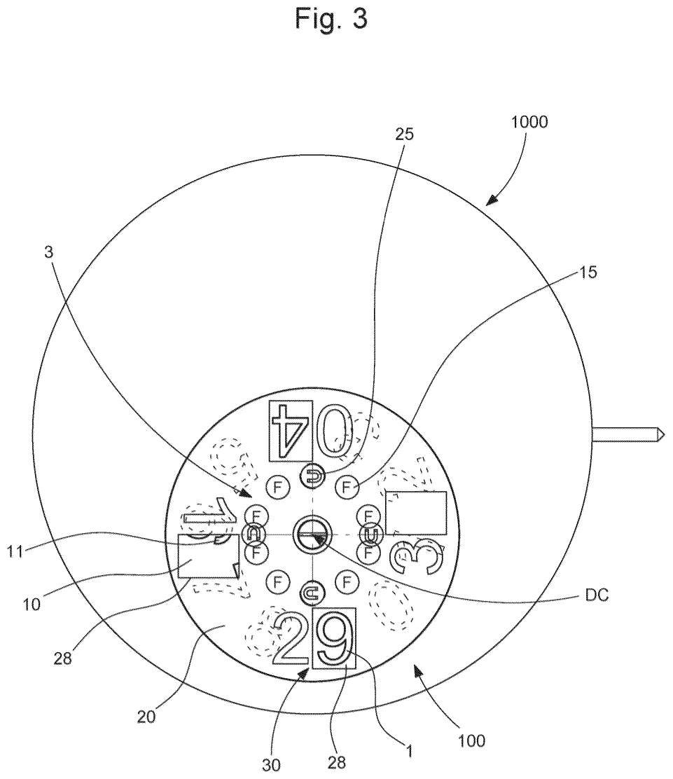

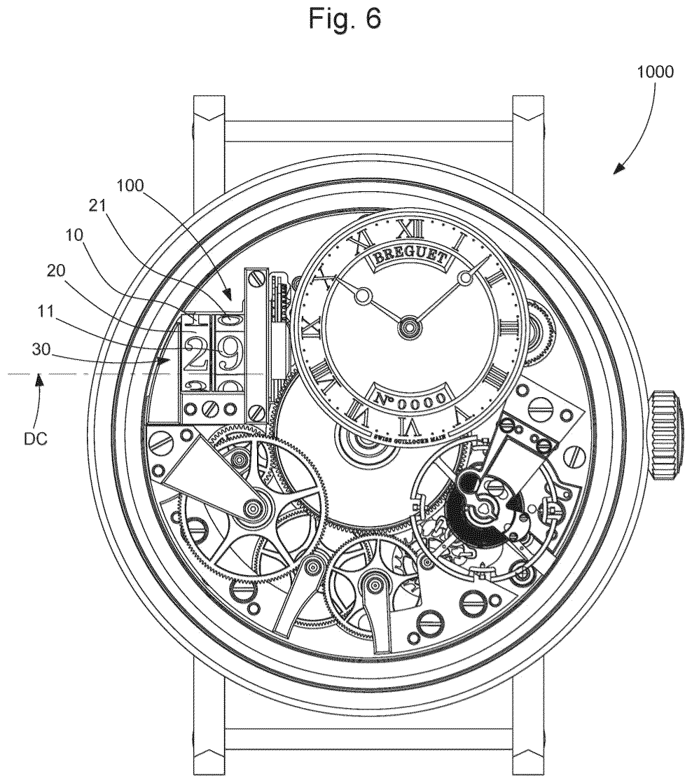

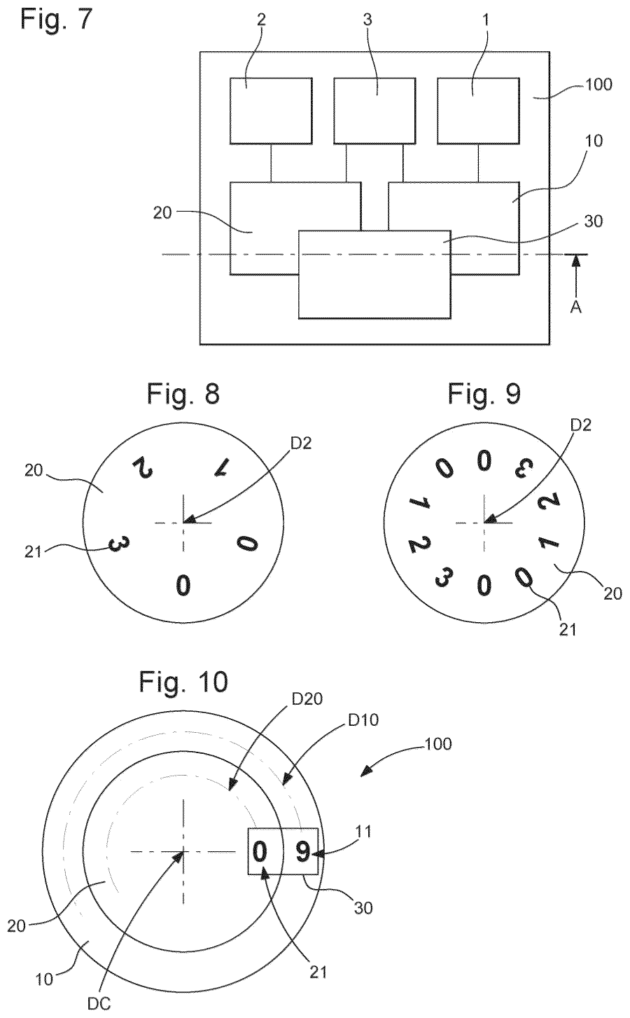

In a first alternative embodiment of the invention, the first display wheel set 10 and the second display wheel set 20 can rotate coaxially. FIGS. 3 to 5 and FIG. 10 illustrate display wheel sets which are discs or rings. FIG. 6 illustrates display wheel sets which are rollers.

More particularly, the ratio between the first number of steps and the second number of steps is an integer number.

More particularly, to obtain an integer number of steps, a plurality of identical indications are repeated on the first display wheel set 10 and/or a plurality of identical indications are repeated on the second display wheel set 20.

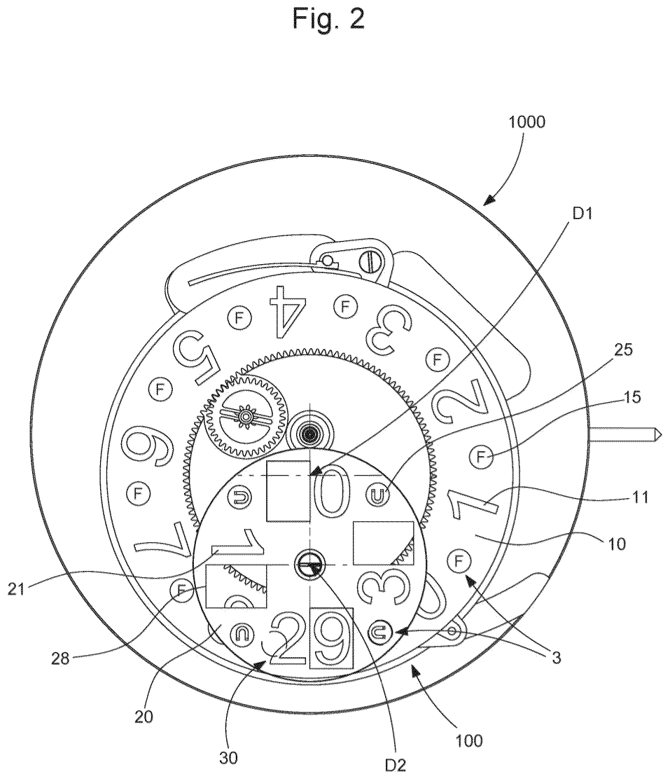

More specifically, the coupling elements 3 comprise at least two couplings for indexing the first display wheel set 10 and the second display wheel set 20 coaxial with one another, which couplings are arranged to provide a magnetic and/or mechanical alignment coupling, and which are distributed according to the display steps. FIGS. 2 to 4 thus show first coupling elements formed by ferromagnetic elements 15 which are rigidly connected to the first display wheel set 10 for rotation therewith, and second coupling elements formed by magnets 25 which are rigidly connected to the second display wheel set 20 for rotation therewith. The ratio between the number of first coupling elements formed by ferromagnetic elements 15 and the number of second coupling elements formed by magnets 25 is an integer, more particularly equal to the ratio between the first number of steps and the second number of steps.

In a particular embodiment, the first display wheel set 10 comprises a first number of positions, which are occupied by first indicators 11 or by first windows 19 or by empty spaces; similarly, the second display wheel set 20 comprises a second number of positions, which are occupied by second indicators 21 or by second windows 28 or by empty spaces. The display area 30 is arranged so as to present to the user, at a given moment, the juxtaposition, in alignment, according to the alignment direction A, on the one hand, on the first display wheel set 10, of either a first indicator 11 for displaying the current value of the first magnitude on the first display wheel set 10, or a first window 19, and on the other hand, on the second display wheel set 20, of either a second indicator 21 for displaying the current value of the second magnitude or a second window 28. It goes without saying that a first indicator 11 or a second indicator 21 can comprise an empty space.

More specifically, the first display wheel set 10 and/or the second display wheel set 20 has a plurality of first indicators 11 and second indicators 21 respectively, which are identical to each other.

More particularly, a plurality of first indicators 11, respectively second indicators 21, which are identical to each other, are consecutive on the first display wheel set 10, respectively the second display wheel set 20, or are grouped into consecutive series of identical indicators.

More particularly, first indicators 11, respectively second indicators 21, which are identical to each other, are empty spots or zero value indicators.

More particularly, as can be seen in FIG. 10, the first display wheel set 10 and the second display wheel set 20 are coaxial discs or rings, the first display wheel set 10 carrying the first indicators 11 over a first diameter, and the second display wheel set 20 carrying the second indicators 21 over a second diameter that is different from the first diameter, and the first indicators 11 and the second indicators 21 are always spaced apart.

More particularly, as can be seen in FIGS. 3 to 5, the first display wheel set 10 and the second display wheel set 20 are coaxial discs or rings, the first display wheel set 10 carrying the first indicators 11 over a first diameter, and the second display wheel set 20 carrying the second indicators 21 over a second diameter that is equal to the first diameter, and the display wheel set of the display wheel sets 10, 20 that has the lowest number of positions, has a viewing window 18, 28, which is adjacent to each of its indicators 11, 21, and through which the other of the display wheel sets 20, 10 is visible, for the combined and aligned viewing of a first indicator 11 and of a second indicator 21 in the display area 30. These figures only show a second window 28, to show how it can be transposed to a first window 18 on the first display wheel set 10.

In a particular embodiment of this first alternative embodiment, illustrated in FIG. 6, the first display wheel set 10 and the second display wheel set 20 are coaxial rollers. More particularly, the first indicators 11 and the second indicators 21 are always spaced apart.

More particularly, the first display wheel set 10 and the second display wheel set 20 are coaxial rollers, and are at least partially overlapping in the display area 30.

More particularly, the rolling display wheel set of the rolling display wheel sets 10, 20 that has the smallest number of positions has a viewing window 18, 28, adjacent to each of its indicators 11, 21, and through which the other of the display wheel sets 20, 10 is visible, for the combined and aligned display of a first indicator 11 and a second indicator 21 in the display area 30.

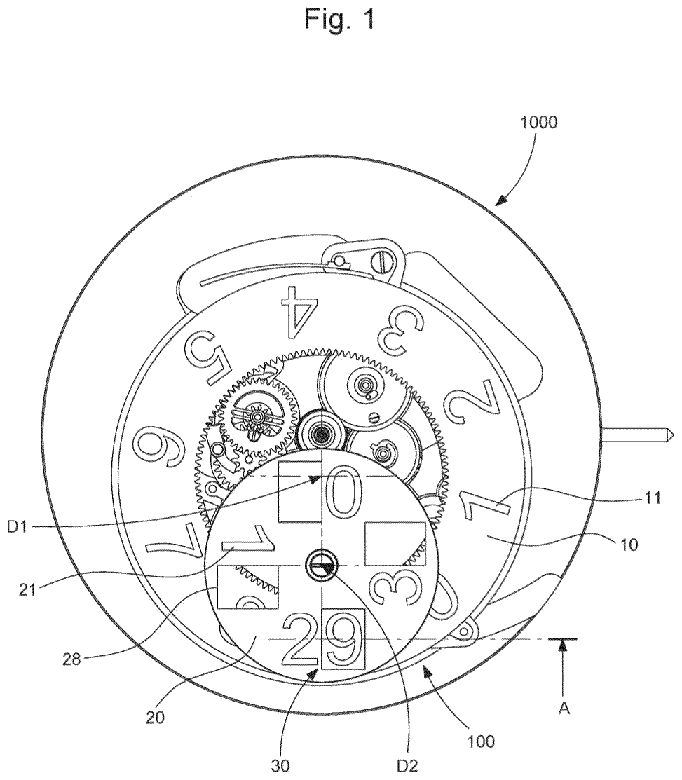

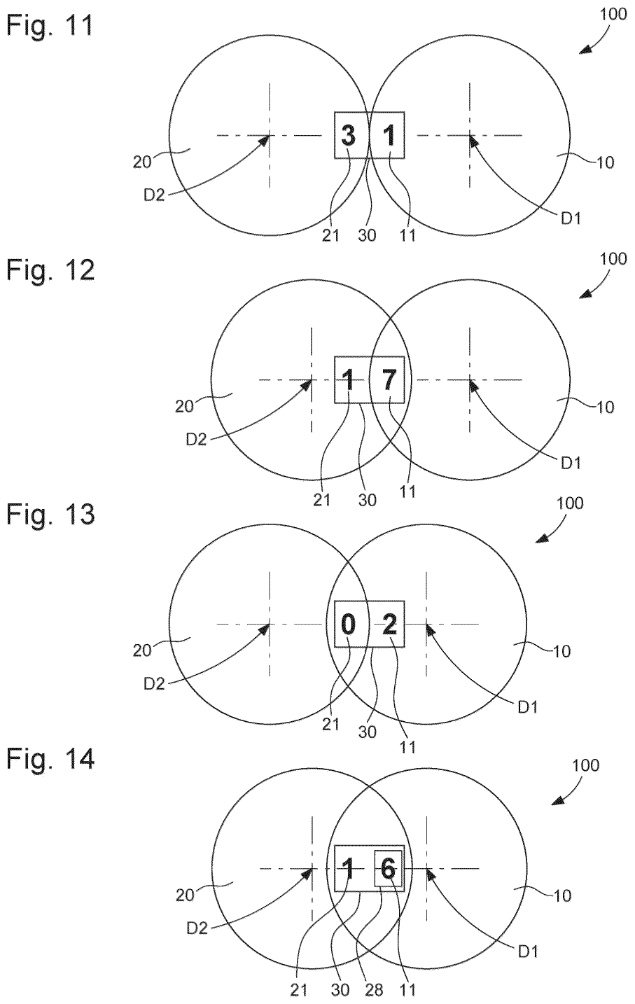

In a second alternative embodiment of the invention, the first display wheel set 10 and the second display wheel set 20 are wheel sets with separate axes, and the first indicators 11 and the second indicators 21 are always spaced apart. FIGS. 1, 2 and 11 to 14 illustrate display wheel sets which are discs or rings.

More particularly, the coupling elements 3 comprise at least two couplings for indexing the first display wheel set 10 and the second display wheel set 20, which couplings are arranged to provide a magnetic and/or mechanical alignment coupling, and which are distributed according to the display steps. These coupling elements can be arranged on the periphery of the wheel sets, in particular on their edges, or the like.

More particularly, the first display wheel set 10 and the second display wheel set 20 are discs or rings with separate axes, and are at least partially overlapping in the display area 30.

More particularly, the display wheel set of the display wheel sets 10, 20 that has the smallest number of positions has a viewing window 18, 28, adjacent to each of its indicators 11, 21, and through which the other of the display wheel sets 20, 10 is visible, for the combined and aligned display of a first indicator 11 and a second indicator 21 in the display area 30.

Different display layouts are possible for both the first alternative embodiment of coaxial wheel sets and for the second alternative embodiment of non-coaxial wheel sets.

Thus, more particularly, the display mechanism 100 is a date display mechanism with discs or rollers, wherein the first display wheel set 10 is a units display wheel set with 10 positions corresponding to the digits from 0 to 9, and the second display wheel set 20 is a tens display wheel set with 5 positions comprising the duplication of one of the tens digits from 0 to 3, as shown in FIGS. 4, 5 and 8, or is a tens display wheel set with 10 positions comprising two sequences of 5 positions, each comprising the duplication of one of the tens digits from 0 to 3, as shown in FIG. 9.

More particularly, the display mechanism 100 is a date display mechanism with rollers, wherein the first display wheel set 10 is a units display wheel set with 5 positions with rotating sections corresponding to the digits 0 to 9, and the second display wheel set 20 is a tens display wheel set with 5 positions comprising the duplication of one of the tens digits 0 to 3.

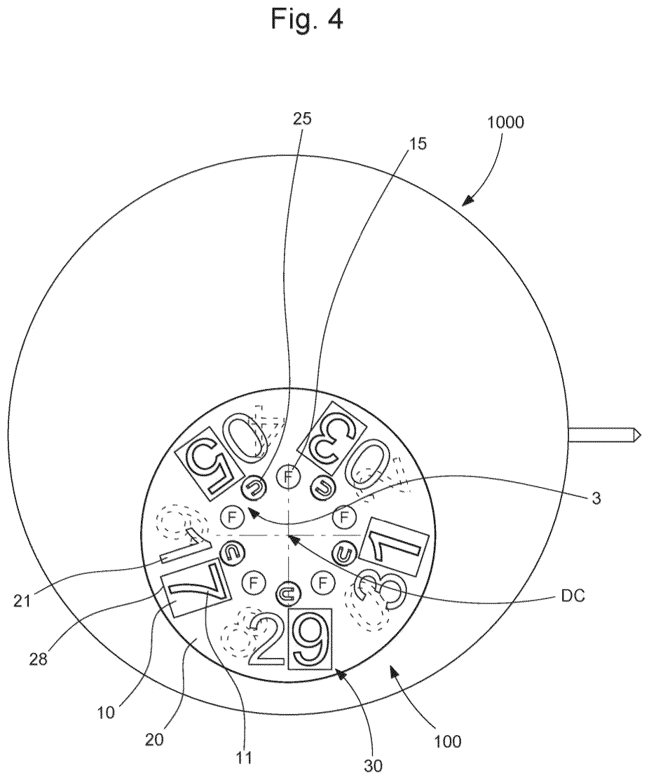

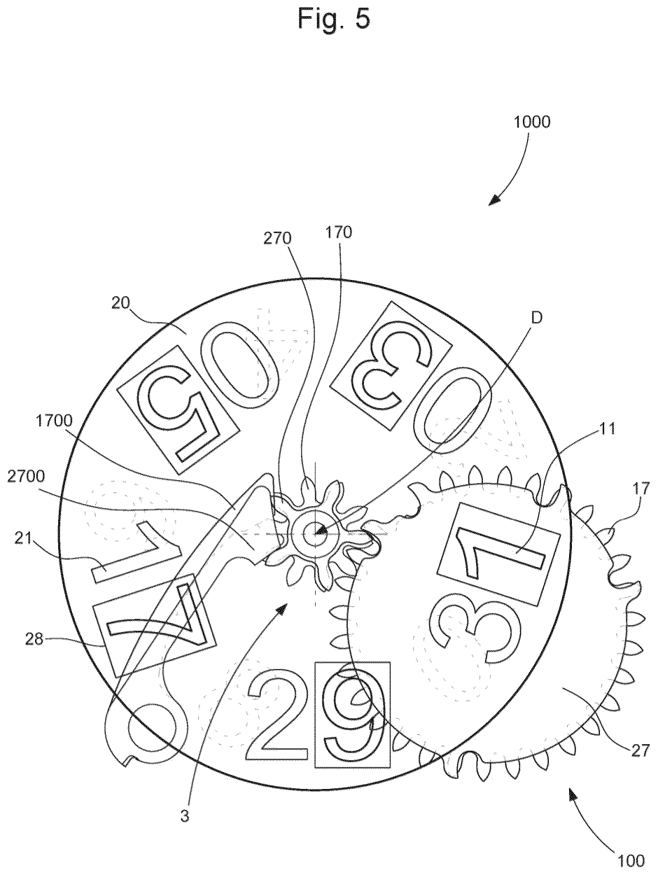

More particularly, the display mechanism 100 is a twenty-four-hour display mechanism with discs or rollers, wherein the first display wheel set 10 is a units display wheel set with 10 positions corresponding to the digits from 0 to 9, and the second display wheel set 20 is a tens display wheel set with 5 positions comprising the duplication of one of the tens digits from 0 to 3 as shown in FIG. 5, or with 10 positions comprising two sequences of 5 positions, each comprising the duplication of one of the tens digits from 0 to 3 as shown in FIG. 9.

More particularly, the display mechanism 100 is a week number display mechanism with discs or rollers, wherein the first display wheel set 10 is a units display wheel set with 10 positions corresponding to the digits from 0 to 9, and the second display wheel set 20 is a tens display wheel set with 10 positions comprising four successive sequences, each comprising the duplication of one of the tens digits from 0 to 5.

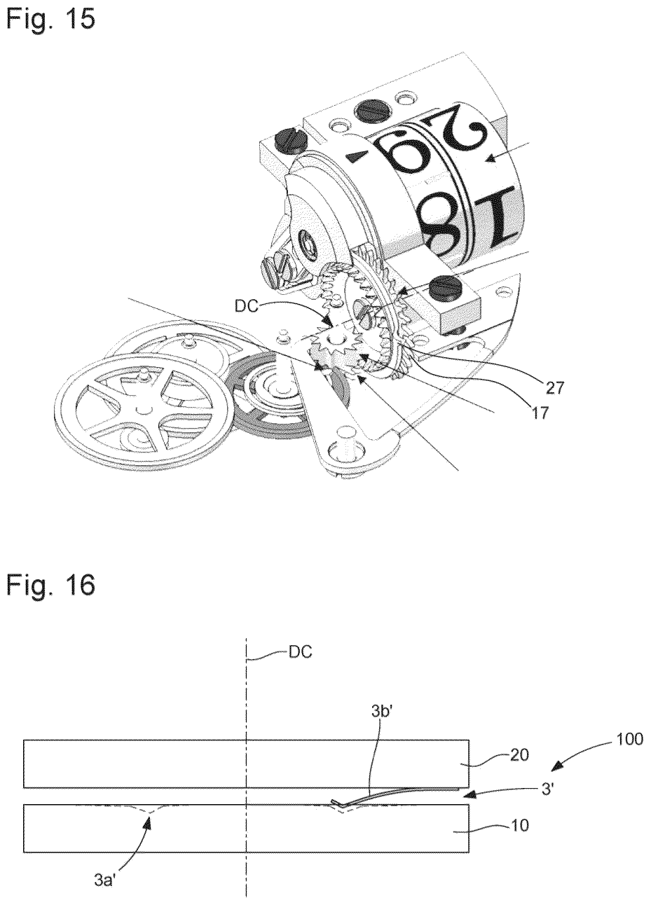

More particularly, and as can be seen in FIG. 15, the first drive elements 1 comprise a first wheel 17 with a truncated toothing, which is arranged to rotate the first display wheel set 10, the missing teeth on the first wheel 17 corresponding to the absence of rotation of the first display wheel set 10 when the second display wheel set 20 has to cover additional steps; and the second drive elements 2 comprise a second wheel 27 with a truncated toothing, which is arranged to rotate the second display wheel set 20, the missing teeth on the second wheel 27 corresponding to the absence of rotation of the second display wheel set 20 when the first display wheel set 10 has to take additional steps.

The invention further relates to a timepiece 1000 comprising at least one such display mechanism 100.

More particularly, at least one such display mechanism 100 is a calendar mechanism.

More particularly, this timepiece 1000 is a watch.

An advantageous application of the invention, constituting a non-limiting example, relates to a date display mechanism, with a first units display wheel set with 10 units positions, and a second tens display wheel set with 5 tens indicators. This mechanism comprises the indexing of the 10 units, particularly magnetically in this example, but which can take place mechanically, relative to the second display, and which can be arranged in phase, with the 5 tens positions relative to the 10 units positions.

FIG. 1 illustrates a display of the big date type of the prior art comprising a display of the 10 units, and thereabove a non-concentric display of the four tens provided with as many windows or openings through which an indicator of the first units display wheel set is visible.

FIG. 2 illustrates an improved mechanism, based on the display mechanism of FIG. 1. The first units display wheel set 10 comprises ten first coupling elements formed by equidistant ferromagnetic elements 15, the second tens display wheel set 20 comprises four second coupling elements formed by equidistant magnets 25. This mechanism solves the problem of aligning the displays, and provides a stable display position; however, this relative indexing of the two displays is only ensured by a single coupling of magnets to ferromagnetic elements, which is not necessarily advantageous, and can still be improved.

FIG. 3 illustrates, in a similar way to FIG. 2, a mechanism improved in the same way, based on a display of the big date type of the prior art comprising a display of the 10 units, and thereabove a display, this time concentric with that of the units, of the four tens provided with as many windows or openings through which an indicator of the first units display wheel set is visible. Ten first coupling elements formed by ferromagnetic units elements 15 are positioned magnetically relative to the four second coupling elements formed by tens magnets 25; as before, it can be seen that, if two second coupling elements formed by tens magnets 25 are opposite two first coupling elements formed by ferromagnetic units elements 15, the other two are offset by half a step and are in contradiction with the first two, this relative guidance of the two display wheel sets is thus not possible with more than one tens magnet, the number of first coupling elements formed by ferromagnetic units elements not being an integer multiple of that of the second coupling elements formed by tens magnets.

In order to obtain the simplest kinematics, in addition to the use of coupling in alignment in the display position, it is thus necessary to ensure compatibility of the coupling elements to ensure direct and rapid positioning, which explains why, preferably, the number of first coupling elements, in particular formed by ferromagnetic units elements is an integer multiple of that of the second coupling elements, in particular formed by tens magnets.

FIG. 4 thus shows a big date display according to the invention comprising a display of the 10 units, and thereabove a concentric display of the 5 tens provided with as many windows or openings through which the unit can be displayed. A magnetic positioning of ten first coupling elements formed by ferromagnetic elements 15 relative to the five second coupling elements formed by tens magnets 25 is suggested. It can be seen that, for each position of the tens and units, the five second coupling elements formed by tens magnets 25 are in phase with 5 out of the 10 first coupling elements formed by ferromagnetic units elements 15, this relative guidance of the two indicators being in fact optimum, the maximum number of magnets being active, due to the fact that the number of first coupling elements formed by ferromagnetic units elements 15 is an integer multiple of that of the second coupling elements formed by tens magnets 25.

The invention thus proposes a so-called “5 tens” configuration which can be adapted to configurations where the tens and units are concentric, such as the configuration shown in FIG. 4, or which can be typical of a rolling date display such as that described in document CH713873, in which the display mechanism comprises two displays, units and tens for example, which must be aligned; each display comprises, on its periphery, at least one magnet cooperating with at least one opposing ferromagnetic element, or with at least one other opposing magnet, from among the magnets distributed over the periphery of the second display, to generate a direct attraction of the two displays towards the aligned position.

The invention is easy to implement on configurations comprising a ring of magnets attracted by another ring of magnets or ferromagnetic elements (steel for example) whose ratio of numbers gives an integer result.

Some non-limitative examples are given below.

To display 5 tens and 10 units on a disc, one solution is to print one of the tens twice, for example the “0” (0-0-1-2-3), and to order the jumping of this ten before the units jump from 9 to 0, for example when the units jump from 4 to 5 (the ratio 10/5=2 is an integer number).

To create a display of 10 tens and 10 units on a disc, one solution is to print the series of units twice, and to repeat one of the tens twice, for example the “0” (0-0-1-2-3-0-0-1-2-3), and to command the jumping of these two repeated tens before the units jump from 9 to 0, for example when the units jump from 4 to 5 (the ratio 10/10=1 is an integer number).

The same rules can be applied to rolling displays:
a tens roller with 2×5 tens, and a units roller with 10 units; the ratio 10/10=1 is an integer;
a tens roller with 1×5 tens, and a units roller with 10 units; the ratio 10/5=2 is an integer;
a tens roller with 5 tens, and a units roller with 5 positions with rotating sections for 10 units, the ratio 5/5=1 is an integer.

The operating sequence for the rolling date with magnetic coupling, in particular with pairs of magnets, can be as follows:
day 1 to 2 of the month: the second tens roller 20 is stationary and shows “0”, the first units roller 10 moves from “1” to “2”, the first 5 magnets 15 and the second 5 magnets 25 ensure the relative positioning of the two indications;
day 4 to 5 of the month: the second tens roller 20 moves from the first “0” indicator to the second “0” indicator that follows it, the first units roller 10 moves from “4” to “5”, the first 5 magnets 15 and the second 5 magnets 25 ensure the relative positioning of the two indications;
day 9 to 10 of the month: the second tens roller 20 moves from the second “0” indicator to “1”, the first units roller 10 moves from “9” to “0”, the first 5 magnets 15 and the second 5 magnets 25 ensure the relative positioning of the two indicators;
day 10 to 11 of the month: the second tens roller 20 is stationary and shows “1”, the first units roller 10 moves from “0” to “1”, the first 5 magnets 15 and the second 5 magnets 25 ensure the relative positioning of the two indications;
day 19 to 20 of the month: the second tens roller 20 moves from “1” to “2”, the first units roller 10 moves from “9” to “0”, the first 5 magnets 15 and the second 5 magnets 25 ensure the relative positioning of the two indications;
day 31 to 1 of the following month: the second tens roller 20 moves from “3” to the first “0” indicator, the first units roller 10 is stationary and shows “1”, the first 5 magnets 15 and the second 5 magnets 25 ensure the relative positioning of the 2 indications.

The rollers are rotated by wheels making 1 revolution per month, the teeth of which are truncated on days when there is no rotation, as shown in FIG. 15. The first units wheel 17, with a truncated toothing, is arranged to rotate the first display wheel set 10; the missing teeth on the first wheel 17 correspond to the absence of rotation of the first display wheel set 10 when the second display wheel set 20 has to take additional steps: 2 missing teeth for no rotation from 31 to 1. The second tens wheel 27, with a truncated toothing, is arranged to rotate the second display wheel set 20; the missing teeth on the second wheel 27 correspond to the absence of rotation of the second display wheel set 20 when the first display wheel set 10 has to take additional steps: 27 missing teeth for rotations only from days 4-5, 9-10, 19-20, 29-30 and 31-1.

In a particular alternative embodiment, the coupling elements 3′ are configured to provide an alignment coupling in a mechanical manner only. In this alternative embodiment, an example of which is illustrated in FIG. 16, one of the display wheel sets 10, 20, for example the first display wheel set 10, has notches 3a′ cooperating with resilient elements 3b′ comprised in the other of the display wheel sets 20, 10, for example the second display wheel set 20, and which are intended to be inserted into the notches 3a′ to define stable indexed alignment positions between the first display wheel set 10 and the second display wheel set 20.

In the example embodiment shown in FIG. 16, the first display wheel set 10 and the second display wheel set 20 are two coaxial discs, or rings, as already described in FIGS. 3 to 5 and 10, with the first display wheel set 10 located below the second display wheel set 20.

By way of example, the first display wheel set 10 can comprise the notches 3a′ on its upper surface, which comprises the first indicators 11, and the second display wheel set 20 can comprise the resilient elements 3b′ on its lower surface, i.e. the surface opposite that which comprises the second indicators 21. It goes without saying that a reverse configuration is also applicable.

This alternative embodiment with purely mechanical coupling elements 3′ is applicable whether the first display wheel set 10 and the second display wheel set 20 are coaxial as shown in FIGS. 3 to 5 and 10 or not coaxial as shown in FIGS. 1 and 2.

Such an alternative embodiment with purely mechanical coupling elements 3′ is applicable whether the first display wheel set 10 and the second display wheel set 20 are overlapping discs or rings, as shown in FIG. 16, or whether the first display wheel set 10 and the second display wheel set 20 are rollers, as shown in FIG. 6. In this case, the notches 3a′ and the resilient elements 3b′ are formed on the respective surfaces thereof that face each other.

The notches 3a′ can be rounded or V-shaped. The resilient elements 3b′ can be strip springs as shown in FIG. 16, or spring-mounted studs or balls configured to cooperate with the notches 3a′ of a consistent shape.

This alternative embodiment with purely mechanical coupling elements 3′ can obviously be combined with all of the alternative embodiments and examples mentioned above insofar as they are technically possible.

This alternative embodiment with mechanical coupling elements 3′ can also be combined, if required, with magnetic coupling elements 3 as described in the previous examples.

This invention can be applied to other displays, and in particular but not exclusively to:
a 24-hour display: 1 disc of 5 tens 0-0-1-1-2 and one disc of 10 units: 10/5=1 is an integer;
a 52-week display: 1 disc of 10 tens 0-0-1-1-2-2-3-3-4-5 and one disc of 10 units: 10/10=1 is an integer.

The invention thus provides a good solution to the known problem of positionally aligning individual display wheel sets combined to produce a complex display grouping a plurality of aligned indicators.

The invention guarantees good indexing of the displays. Although the invention has been described for the most common case of a combination of two display wheel sets, it can also be used for more complex displays, with a greater number of display wheel sets.

The invention limits play in the displays, which eliminates overlapping phenomena which can be displeasing to the user.

Rolling date display mechanisms, or so-called “big date” displays, typically comprise two separate displays for the units and tens, and are very advantageous applications of the invention. Other, less well-known types of display can use the same type of display comprising tens and units, such as weekly calendars or jumping hours, etc.; it goes without saying that the invention can be applied to other numbers of positions on the display wheel sets, for example 7, 12, or other numbers.

In short, the multiplication of an indicator, such as a zero in the non-limiting example illustrated, on a display wheel set, is very advantageous for obtaining good relative positioning of the two complementary displays.

1. A horological display mechanism comprising at least first drive elements arranged to rotate a first display wheel set through a first number of steps in order to display a first magnitude, and second drive elements arranged to rotate a second display wheel set through a second number of steps in order to display a second magnitude, wherein the display mechanism comprises coupling elements, which are separate from said first drive elements and said second drive elements, and which are arranged to index said first display wheel set and said second display wheel set relative to each other, to ensure their alignment, in an alignment direction (A), in a display area comprised in the display mechanism.

2. The display mechanism according to claim 1, wherein the ratio between said first number of steps and said second number of steps is an integer number.

3. The display mechanism according to claim 2, wherein in order to obtain an integer number of steps, a plurality of identical indications are repeated on said first display wheel set and/or a plurality of identical indications are repeated on said second display wheel set.

4. The display mechanism according to claim 1, wherein said coupling elements are arranged to produce a magnetic and/or mechanical alignment coupling.

5. The display mechanism according to claim 1, wherein said first display wheel set (10) and said second display wheel set (20) rotate coaxially.

6. The display mechanism according to claim 2, wherein said first display wheel set and said second display wheel set rotate coaxially and in that said coupling elements comprise, in order to ensure the indexing of said first display wheel set and said second display wheel set, which are coaxial with one another, at least two couplings arranged to produce a magnetic and/or mechanical alignment coupling, and distributed according to the display steps.

7. The display mechanism according to claim 1, wherein said first display wheel set comprises a first number of positions occupied by first indicators or by first windows or by empty spaces, in that said second display wheel set comprises a second number of positions occupied by second indicators or by second windows or by empty spaces, in that said display area is arranged to show the user, at a given moment, the juxtaposition in alignment, on said first display wheel set, of either a said first indicator for displaying the current value of said first magnitude on said first display wheel set or a said first window, and, on said second display wheel set, either a said second indicator for displaying the current value of said second magnitude or a said second window.

8. The display mechanism according to claim 7, wherein said first display wheel set and/or said second display wheel set comprises a plurality of said first indicators, respectively second indicators, which are identical to each other.

9. The display mechanism according to claim 7, wherein said first display wheel set (10) and said second display wheel set (20) rotate coaxially, wherein said first display wheel set and said second display wheel set are coaxial discs or rings, said first display wheel set carrying said first indicators over a first diameter and said second display wheel set carrying said second indicators over a second diameter that is different from said first diameter, and in that said first indicators and said second indicators are always spaced apart from one another.

10. The display mechanism according to claim 7, wherein said first display wheel set (10) and said second display wheel set (20) rotate coaxially and wherein said first display wheel set and said second display wheel set are coaxial discs or rings, said first display wheel set carrying said first indicators over a first diameter, and said second display wheel set carrying said second indicators over a second diameter that is equal to said first diameter, and in that that the display wheel set of said display wheel sets which has the smallest number of positions has a viewing window adjacent to each of its indicators and through which the other of said display wheel sets is visible for the combined and aligned viewing of a said first indicator and a said second indicator in said display area.

11. The display mechanism according to claim 7, wherein said first display wheel set and said second display wheel set are coaxial rollers, and in that said first indicators and said second indicators are always spaced apart.

12. The display mechanism according to claim 7, wherein said first display wheel set and said second display wheel set are coaxial rollers, and are at least partially overlapping in said display area.

13. The display mechanism according to claim 12, wherein the display wheel set of said display wheel sets which has the lowest number of positions has a viewing window adjacent to each of its indicators and through which the other of said display wheel sets is visible for the combined and aligned viewing of a said first indicator and a said second indicator in said display area.

14. The display mechanism according to claim 1, wherein said display mechanism is a date display mechanism with discs or rollers, wherein said first display wheel set is a units display wheel set with 10 positions corresponding to the digits from 0 to 9, and said second display wheel set is a tens display wheel set with 5 positions comprising the duplication of one of the tens digits from 0 to 3, or with 10 positions comprising two sequences of 5 positions each and comprising the duplication of one of the tens digits from 0 to 3.

15. The display mechanism according to claim 1, wherein said display mechanism is a rolling date display mechanism, wherein said first display wheel set is a units display wheel set with 5 positions and rotational sections corresponding to the digits from 0 to 9, and said second display wheel set is a tens display wheel set with 5 positions comprising the duplication of one of the tens digits from 0 to 3.

16. A timepiece comprising at least one said display mechanism according to claim 1.

17. The timepiece according to claim 16, wherein at least one said display mechanism is a calendar mechanism.

18. The timepiece according to claim 16, wherein said timepiece is a watch.
